(19) United States
(12) Patent Application Publication
(10) Pub. No.: US 2025/0230793 A1
(43) Pub. Date: Jul. 17, 2025

(54) A WIND TURBINE WITH BLADE CONNECTING TENSION MEMBERS

(71) Applicant: VESTAS WIND SYSTEMS A/S, Aarhus N (DK)

(72) Inventors: Mikkel Kiilerich ØSTERLUND, Brabrand (DK); Robert Thomas RUDOLF, Aarhus C (DK); Torben Juul LARSEN, Roskilde (DK); Luis Daniel COSTA GONCALVES SILVA CRUZ, Areias de Vilar (PT); Erik SLOTH, Rønde (DK); Thomas S. Bjertrup NIELSEN, Skødstrup (DK)

(21) Appl. No.: 18/875,579

(22) PCT Filed: Jun. 9, 2023
(86) PCT No.: PCT/DK2023/050143

§ 371 Date: Dec. 16, 2024

(30) Foreign Application Priority Data
Jun. 14, 2022 (DK) PA202270317

(51) Int. Cl. F03D 1/06; F03D 9/25; F03D 13/20

(52) U.S. Cl. CPC F03D 1/0633; F03D 9/255; F03D 13/201; F05B 2220/706; F05B 2240/306

(57) ABSTRACT

A wind turbine comprising a tower, a nacelle, a hub, and three or more wind turbine blades is disclosed. The wind turbine further comprises blade connecting tension members, each blade connecting tension member extending between a connection point at one wind turbine blade and a connection point at a neighbouring wind turbine blade. Each blade connecting tension member comprises a tension member core, and a surface texture providing layer. arranged circumferentially with respect to the tension member core, thereby modifying a surface texture of an outer surface of the blade connecting tension member. This reduces the drag as well as the noise originating from blade connecting tension members. Furthermore a tension member is disclosed.

### FIELD OF THE INVENTION

The present invention relates to a wind turbine comprising three or more wind turbine blades, where blade connecting tension members extend between connection points at neighbouring wind turbine blades. The present invention further provides such a blade connecting tension member.

### BACKGROUND OF THE INVENTION

During operation of a wind turbine, as well as during standstill, the components of the wind turbine are subjected to various loads. For instance, the wind turbine blades of the wind turbine are subjected to loads originating from gravity acting on the wind turbine blades, loads originating from wind pressure on the wind turbine blades, loads originating from changes in wind direction, turbulence, etc.

As the size of wind turbine blades increases, the loads on the wind turbine also increase. In order to handle such increased loads, the amount of material used for manufacturing the wind turbine may be increased. However, this increases the weight as well as the manufacturing costs of the wind turbine.

As an alternative to increasing the amount of material used for the wind turbine, in particular for the wind turbine blades, the wind turbine may be provided with blade connecting tension members, e.g. in the form of wires, i.e. blade connecting tension members which interconnect the wind turbine blades. Such blade connecting tension members cause the wind turbine blades to mutually support each other, in the sense that a part of the loads on the wind turbine blades are ‘shared’ among the wind turbine blades, via the blade connecting tension members.

Introducing such blade connecting tension members may increase a drag of the rotor of the wind turbine, thereby reducing the energy which the wind turbine is able to extract from the wind. Furthermore, the blade connecting tension members may increase the noise generated by the wind turbine.

### DESCRIPTION OF THE INVENTION

It is an object of embodiments of the invention to provide a wind turbine with blade connecting tension members extending between the wind turbine blades, in which the energy extraction from the wind is increased as compared to similar prior art wind turbines.

It is a further object of embodiments of the invention to provide a wind turbine with blade connecting tension members extending between the wind turbine blades, in which the noise generated by the wind turbine is reduced as compared to similar prior art wind turbines.

It is an even further object of embodiments of the invention to provide a wind turbine with blade connecting tension members extending between the wind turbine blades, in which good support among the wind turbine blades is provided without unduly reducing the energy extraction from the wind and without unduly increasing the noise generated by the wind turbine.

It is an even further object of embodiments of the invention to provide a blade connecting tension member for use in a wind turbine, which introduces a decreased drag as compared to prior art blade connecting tension members.

According to a first aspect the invention provides a wind turbine comprising a tower, a nacelle mounted on the tower, a hub mounted rotatably on the nacelle, and three or more wind turbine blades, wherein each wind turbine blade extends between a root end connected to the hub, and a tip end arranged opposite to the root end, the wind turbine further comprising blade connecting tension members, each blade connecting tension member extending between a connection point at one wind turbine blade and a connection point at a neighbouring wind turbine blade, where the connection point at a given wind turbine blade is arranged at a distance from the root end and at a distance from the tip end of the wind turbine blade, wherein each blade connecting tension member comprises:
a tension member core, and
a surface texture providing layer arranged circumferentially with respect to the tension member core, thereby modifying a surface texture of an outer surface of the blade connecting tension member.

Thus, according to the first aspect, the invention provides a wind turbine comprising a tower with a nacelle mounted thereon, preferably via a yaw system. A hub carrying three or more wind turbine blades is mounted rotatably on the nacelle. The hub and the wind turbine blades may be referred to as a rotor. During operation, the rotor is positioned in accordance with the wind direction by appropriately operating the yaw system. The wind turbine blades catch the wind and cause the hub to rotate. This rotation is then transferred to a generator, possibly via a gear system, where the mechanical energy is transformed to electrical energy, which may then be supplied to a power grid.

Each wind turbine blade extends between a root end connected to the hub, possibly via a pitch system, and a tip end arranged opposite to the root end. Thus, each wind turbine blade extends radially outwards from the hub optionally at a smaller coning angle.

The wind turbine further comprises blade connecting tension members. Each blade connecting tension member extends between a connection point at one wind turbine blade and a connection point at a neighbouring wind turbine blade. Accordingly, each blade connecting tension member interconnects two neighbouring wind turbine blades, i.e. wind turbine blades which are connected to the hub adjacent to each other. The blade connecting tension members may, e.g., be in the form a wire, a cable, or any other suitable kind of tension member.

The connection point at a given wind turbine blade is arranged at a distance from the root end and at a distance from the tip end. Accordingly, the connection point is neither positioned at the root end, nor at the tip end, i.e. it is not positioned at an extremity of the wind turbine blade. Rather, it is positioned at an appropriate intermediate position between the root end and the tip end. This will be described in further detail below.

Thus, the blade connecting tension members cause the wind turbine blades to mutually support each other, in the sense that loads on the wind turbine blades, in particular edgewise loads and flapwise loads, are ‘shared’ among the wind turbine blades, via the blade connecting tension members. Thereby the loads on the wind turbine blades, during operation as well as during standstill, can be handled by a lower material thickness, and thereby decreased weight and lower manufacturing costs.

Each blade connecting tension member comprises a tension member core and a surface texture providing layer. The surface texture providing layer is arranged circumferentially with respect to the tension member core. Thereby the surface texture providing layer modifies a surface texture of an outer surface of the blade connecting tension member.

Since the surface texture providing layer is arranged circumferentially with respect to the tension member core, the outer surface of the surface texture providing layer also forms the outer surface of the blade connecting tension member. Thereby a texture and a roughness defined by the surface texture providing layer also defines the surface texture and surface roughness of the blade connecting tension member. In other words, the surface texture providing layer changes or modifies the surface texture of the outer surface of the blade connecting tension member, as compared to a surface texture defined by the tension member core without the surface texture providing layer applied thereto.

Accordingly, by appropriately selecting or defining the surface texture providing layer, a desired surface texture and/or a desired surface roughness of the blade connecting tension member can be obtained. In addition, the surface texture providing layer may serve as a protecting layer of the core from wind and wear, such as UV exposure and/or rain erosion. Furthermore, the tension member core can still be selected or designed in a manner which fulfils structural requirements of the blade connecting tension member, e.g. in terms of strength, durability, elasticity, etc, without also having to consider the aspects provided by the surface texture providing layer. This allows for a less restricted and hence more efficient choice of core material for example allowing for higher specific strength and/or more affordable material for the core material.

The surface texture of an object has an impact on the aerodynamical properties of an object. It has been found by the inventors of the present invention that applying surface texture to the blade connecting tension member, rather than simply using blade connecting tension members with a relatively smooth surface and a substantially cylindrical shape, the aerodynamical properties of the blade connecting tension members can be changed in such a manner that the drag introduced by the blade connecting tension members, as well as the noise originating from the blade connecting tension members, is reduced. Thereby the mutual support of the wind turbine blades can be obtained without unduly decreasing the ability of the wind turbine to extract energy from the wind, and without unduly increasing the noise generated by the wind turbine.

The surface texture providing layer may define a surface roughness within an interval defined as 0.100 mm<Ra<0.400 mm, such as 0.200 mm<Rₐ<0.300 mm, and/or within an interval defined as 0.200 mm<R_{z}<0.500 mm, such as 0.300 mm<R_{z}<0.400 mm. The values above are particularly relevant for a blade connecting tension member with a diameter of approximately 70 mm. In the case that the diameter is smaller, a lower surface roughness may be appropriate, and in the case that the diameter is larger, a higher surface roughness may be appropriate. An appropriate normalized measure for the roughness could be 0.0014<Ra/D<0.0057, such as 0.0029<Rₐ/D<0.0043, and/or 0.0029<R_{z}/D<0.0071, such as 0.0043<R_{z}/ D<0.0057, where D is the diameter of the blade connecting tension member. It should be observed that the above preferred ranges for Rₐ and R_{z}are for “macroscopic” roughness (see below) for the outer surface of the surface texture providing layer.

The intervals above may be defined on an evaluation scale or filter scale, which is comparable to the lengths of the blade connecting tension members, between the relevant connection points. Accordingly, these parameters and intervals may be regarded as a ‘macroscopic’ roughness of the surface texture providing layer, or as a ‘low frequency’ roughness. A sample length, or cut-off length, λ_{c}, for the ‘macroscopic’ roughness may be λ_{c}=60 mm. Correspondingly, a sample length, or cut-off length, for a ‘microscopic’ roughness may be λ_{c}=0.8 mm.

According to ISO standards 16610-1 and 16610-21, the parameter Rₐ is defined as a mean value of deviations in surface position from an average surface position. Accordingly, Rₐ is a measure for the size of hills and valleys formed on the surface, as an average consideration. Outliers in the form of very large or very small deviations will have only little impact on the parameter Rₐ.

Furthermore, according to ISO standards 16610-1 and 16610-21, the parameter R_{z} is defined as the difference between a representative sample of the largest deviations from the average surface position and a representative sample of the smallest deviations from the average surface position. Accordingly, R_{z} reflects extremities in the deviations from the average surface position and is therefore a measure for the size of fluctuations in surface positions. Outliers in the form of very large or very small deviations have a significant impact on the parameter R_{z}.

It has been found by the inventors of the present invention that some surface roughness will improve the aerodynamic properties of the blade connecting tension member, but that too high a surface roughness may have a detrimental effect. A roughness as defined by the intervals above is therefore suitable.

For instance, Rₐ may be within the interval 0.100 mm-0.400 mm, such as within the interval 0.200 mm-0.300 mm, such as within the interval 0.220 mm-0.280 mm, such as within the interval 0.230 mm-0.270 mm.

Similarly, R_{z} may be within the interval 0.200 mm-0.500 mm, such as within the interval 0.300 mm-0.400 mm, such as within the interval 0.320 mm-0.380 mm, such as within the interval 0.330 mm-0.370 mm.

The surface roughness of the surface texture providing layer on a microscopic scale, or a high frequency scale, may be significantly lower than the surface roughness on the macroscopic scale, such as 1-3 orders of magnitude lower. For instance, on the microscopic scale, Rₐ may be within the interval 0.700 μm-1.400 μm, such as within the interval 0.800 μm-1.200 μm, such as approximately 1.000 μm.

Thus, the surface texture may define hills and valleys on a macroscopic scale, while it may be very smooth on a microscopic scale.

The surface texture described above causes a reduction in vortex induced vibrations in the blade connecting tension members. This reduces drag as well as noise originating from the blade connecting tension members.

The surface texture providing layer may comprise an inner layer arranged circumferentially with respect to the tension member core and an outer layer arranged circumferentially with respect to the inner layer, and the inner layer may define a higher surface roughness than the outer layer.

According to this embodiment, the surface texture providing layer comprises two layers, i.e. the inner layer and the outer layer, arranged concentrically with respect to each other and with respect to the tension member core, and with the inner layer arranged between the tension member core and the outer layer. Furthermore, an outer surface of the outer layer forms the outer surface of the surface texture providing layer, and thereby the outer surface of the blade connecting tension member.

According to this embodiment, the blade connecting tension member may, e.g., be made by applying the inner layer to the tension member core, and subsequently applying the outer layer to the inner layer. Since the inner layer defines a higher surface roughness than the outer layer, the inner layer provides the geometry of the surface texture, and the outer layer smoothens the surface texture defined by the inner layer. Thereby an appropriate surface roughness of the resulting blade connecting tension member is obtained.

The outer layer may be or comprise a thermoplastic shrink foil. According to this embodiment, the outer layer is arranged circumferentially with respect to the inner layer. Then heat is applied to the outer layer in order to shrink it, thereby causing the outer layer to follow the surface texture defined by the inner layer, but in a manner which smoothens the surface texture. This is an easy manner of providing the inner and outer layers.

As an alternative, the outer layer may be provided in the form of a woven or braided layer, a coating or in the form of an extruded layer, e.g. a plastomer layer.

The inner layer may be or comprise a woven or braided layer. According to this embodiment, the inner layer may be woven or braided directly onto the tension member core, e.g. by arranging yarn in an appropriate pattern. Alternatively, the woven or braided layer may be manufactured separately, and subsequently arranged circumferentially with respect to the tension member core.

According to this embodiment, the surface texture is defined by a pattern of the woven or braided layer. Accordingly, the surface texture may be cyclically repeating and/or evenly distributed along a circumference of the blade connecting tension member and/or along the length of the blade connecting tension member. Alternatively, the surface texture may vary along the length of the blade connecting tension member.

The blade connecting tension member may further comprise one or more surface shaping elements arranged between the tension member core and an outer surface of the surface texture providing layer.

According to this embodiment, the surface texture is at least partly provided by the one or more surface shaping elements. Accordingly, the surface texture may be less regular and/or more ‘local’ than is the case if the surface texture is provided by a woven or braided layer, or a similar regular pattern.

The surface shaping elements may, e.g., be in the form of triangular elements, aerodynamic profiles, tabs, a ribbon, axially-oriented ribs, helical strakes, helically-wrapped wires, hemispherical bumps, sand-like particles, circular vortex generators, dimples, grooves, etc. The surface shaping elements may be arranged in a repeating pattern, such as regular helical strakes, tabs, ribbons or bumps. In another example, the surface shaping elements may be arranged in a pattern varying along the length of the blade connecting tension member. Specifically, the surface shaping elements may be arranged closer along the length of the blade connecting tension member with the highest density of the surface shaping elements near one of the blades and the lowest density of the surface shaping elements near the other blade. In another example, the surface shaping elements may be arranged closer on the blade connecting tension member near the middle of the blade connecting tension member and less close towards the ends of the blade connecting tension member as this allows for similar effective angle of contact between air and surface shaping elements due to variation in speed of the movement of the blade connecting tension member through the air during operation of the wind turbine. Alternatively, the surface shaping elements may be arranged closer on the blade connecting tension member near the ends of the blade connecting tension member and less close towards the middle of the blade connecting tension member as this allows for a higher variation of the effective angle of contact between air and surface shaping elements due to variation in speed of the movement of the blade connecting tension member through the air during operation of the wind turbine and hence the risk of standing waves of sound with same frequency along a longer part of the blade connecting tension member is reduced. Specifically, it is preferred that the surface shaping element providing helical strakes and more preferably, helical strakes with varying pitch along the length of the blade connecting tension member.

The surface shaping elements may, e.g., be mounted directly on the tension member core, and the surface texture providing layer may be arranged circumferentially with respect to the tension member core with the surface shaping elements arranged thereon, i.e. on top of the surface shaping elements. Thereby the surface texture providing layer will adapt to the shape of the surface shaping elements, and the resulting blade connecting tension member will have a surface texture which is defined by the surface shaping elements.

As an alternative, the surface shaping elements may be formed directly on an outer surface of the surface texture providing layer. In this case, the surface shaping elements define the surface texture directly.

As another alternative, in the case that the surface texture providing layer comprises an inner layer and an outer layer, the surface shaping elements may form part of the inner layer, and/or the surface shaping elements may be arranged between the inner layer and the outer layer.

For instance, the inner layer may comprise an element, e.g. in the form of a ribbon or a rope, arranged in a helix pattern on an outer surface of the tension member core or on an outer surface of the inner layer. In this case, the surface texture defines a helical shape.

The tension member core may be made from a polymer material. The polymer material may, e.g., be an Ultra High Molecular Weight Polyethylene, e.g. of the kind being manufactured under the tradename ‘Dyneema’. Ultra High Molecular Weight Polyethylene fibres has a high strength/weight ratio and good fatigue properties.

As an alternative, the polymer material may be based on polyester, polyamid, nylon, polypropylene, aramid, etc. As another alternative, the polymer material may be composite materials, e.g. a liquid crystal polymer, such as polybenzoxazole (PBO).

As an alternative to a polymer material, the tension member core may be made from steel, e.g. in the form of a steel wire, or carbon fibres. In the latter case the tension member core may be provided as a composite member by means of carbon pultrusion.

A thickness of the surface texture providing layer may be at most 15% of a cross sectional diameter of the tension member core as measured on a cross section of the blade connecting tension member. For example, a cross sectional diameter of a blade connecting tension member of 50 mm with a cross sectional diameter of a tension member core of 40 mm would yield a thickness of the surface texture providing layer of (50 mm-40 mm)/2=5 mm, which again is 5 mm/40 mm=12.5% of the cross sectional diameter of the tension member core. According to this embodiment, the tension member core forms the majority of the blade connecting tension member, while the surface texture providing layer may constitute only a thin layer circumferentially on the tension member core. Thereby the mechanical properties of the tension member core define the mechanical properties of the tension member, whereas the surface properties of the surface texture providing layer define the surface properties of the tension member. Preferably the thickness of the surface texture providing layer is at most 10% of the cross sectional diameter of the tension member core and more preferred at most 5% of the cross sectional diameter of the tension member core. The thickness of the surface texture providing layer may be very low, for example if the surface texture providing layer is a coating and the tension member core is relatively thick. For example, the thickness of the surface texture providing layer may be at least 0.1% of the cross sectional diameter of the of the tension member core, but preferably the thickness of the surface texture providing layer is at least 2% of the cross sectional diameter of the of the tension member core, and more preferably at least 4% of the cross sectional diameter of the of the tension member core.

The structural requirements of the blade connecting tension member in terms of strength is preferably almost exclusively from the tension member core. The blade connecting tension member is accelerating and moving through the air at high speed during operation of wind turbine. For a tension member to be suitable as a blade connecting tension member, it is therefore required to be light and for example not comprising large amounts of metal not enhancing structural strength. Large amounts of metal, such as electrical conductors capable of carrying a permanent high power in the order of MW, would also increase the diameter of the blade connecting tension member and hence increase the drag of the cable during the operation of the wind turbine due to the position of the blade connecting tension members between the blades. In one embodiment, it is preferred that the cross sectional area of the tension member core excluding metal is at least 90% of the cross sectional area of the blade connecting tension member. In another embodiment, the cross sectional area of the tension member core excluding metal is at least 95% of the cross sectional area of the blade connecting tension member.

An ultraviolet (UV) resistance of the surface texture providing layer may be higher than an ultraviolet (UV) resistance of the tension member core. According to this embodiment, the surface texture providing layer protects the blade connecting tension member against UV radiation. In particular, the surface texture providing layer protects the blade connecting tension member from degradation caused by exposure to UV radiation, e.g. originating from sunlight.

The improved UV resistance may, e.g., be sufficient to increase the expected lifetime of the blade connecting tension member by at least three years as compared to the expected lifetime of a ‘naked’ tension member core. In the case that the expected lifetime of a ‘naked’ tension member core is approximately 1 year, this corresponds to an increase in expected lifetime of at least 300%.

Alternatively or additionally, an erosion resistance of the surface texture providing layer may be higher than an erosion resistance of the tension member core. According to this embodiment, the surface texture providing layer protects the blade connecting tension member from degradation due to erosion, e.g. caused by exposure to wind and weather.

The improved erosion resistance may, e.g., be sufficient to increase the expected lifetime of the blade connecting tension member by at least three years as compared to the expected lifetime of a ‘naked’ tension member core. In the case that the expected lifetime of a ‘naked’ tension member core is approximately 1 year, this corresponds to an increase in expected lifetime of at least 300%. Alternatively, the improved erosion resistance may lead to the tension member core not being exposed to erosion during use and hence that replacement of the surface texture providing layer or addition of a further surface texture providing layer during the lifetime of the blade connecting tension member would be possible without having to consider erosion wear of the tension member core.

Alternatively or additionally, an aerodynamic drag defined by the surface texture providing layer may be lower than an aerodynamic drag defined by the tension member core, e.g. at least 20% lower, such as at least 40% lower or even at least 50% lower. Particularly, an aerodynamic drag defined by the blade connecting tension member including the surface texture providing layer may be lower than an aerodynamic drag defined by the tension member core, i.e. without the surface texture providing layer, e.g. at least 20% lower, such as at least 40% lower or even at least 50% lower, even if the diameter of the blade connecting tension member has a larger diameter than the tension member core alone.

Alternatively or additionally, an acoustic emission of the surface texture providing layer may be lower than an acoustic emission of the tension member core, e.g. at least 3 dB lower, such as at least 5 dB lower. Particularly, an acoustic emission of the blade connecting tension member including the surface texture providing layer may be lower than an acoustic emission of the tension member core, i.e. without the surface texture providing layer, e.g. at least 3 dB lower, such as at least 5 dB lower, even if the diameter of the blade connecting tension member has a larger diameter than the tension member core alone.

The connection points at the wind turbine blades may be arranged at a distance from the root end which is between 25% and 60% of the length of the wind turbine blades from the root end to the tip end, such as between 30% and 55% of the length of the wind turbine blades, such as between 40% and 50% of the length of the wind turbine blade.

According to this embodiment, the connection points on the wind turbine blades are arranged at a position which is well clear of the root end as well as the tip end of the wind turbine blades.

The position of the connection points along the wind turbine blades may be selected in a manner which suitably balances various issues which need to be taken into consideration. For instance, positioning the connection point close to the tip end of the wind turbine blade results in very efficient support to the wind turbine blades by the blade connecting tension members. However, this comes at a price of a high drag caused by the blade connecting tension members during rotation of the rotor, and thereby decreased energy production. On the other hand, positioning the connection point close to the root end of the wind turbine blade results in a low drag caused by the blade connecting tension members, thereby minimising the adverse impact on the energy production of the wind turbine. However, the support to the wind turbine blades by the blade connecting tension members will not be very efficient. By positioning the connection points at a distance from the root end which is between 25% and 60% of the length of the wind turbine blade, these considerations are balanced in such a manner that efficient support is obtained without introducing an unacceptable drag. Furthermore, by positioning the connecting points within this region it is ensured that the blade connecting tension members are attached to the wind turbine blades where a structural stiffness of the wind turbine blade is sufficiently high. For instance, the structural stiffness of the wind turbine blade decreases towards the tip end, and connecting the blade connecting tension members too near the tip end may therefore create a significant pre-deformation of the wind turbine blade.

The wind turbine may be a pitch controlled wind turbine. According to this embodiment, the wind turbine blades are connected to the hub via respective pitch systems and the connection points at the wind turbine blade for the blade connecting tension member cable are arranged to allow for pitching of the blades so the wind turbine blades are able to perform pitching movements relative to the hub, about a longitudinal axis arranged along the length of the wind turbine blades, in order to adjust an angle of attack between the wind turbine blades and the incoming wind.

The wind turbine may further comprise pre-tension members arranged from each blade connecting tension member and towards a hub part. Accordingly, the pre-tension members pull the blade connecting tension members toward the hub, and thereby the pre-tension members provide tension to the blade connecting tension members, so the blades connected by the blade connecting tension members are tensioned adjustably via an actuator arranged between the pre-tension member and the hub part. The pretension member may comprise a tension member core and a surface texture providing layer as described elsewhere in this document

According to a second aspect the invention provides a blade connecting tension member for use in a wind turbine, the blade connecting tension member comprising:
a tension member core, and
a surface texture providing layer arranged circumferentially with respect to the tension member core, thereby modifying a surface texture of an outer surface of the blade connecting tension member.

The blade connecting tension member according to the second aspect of the invention has already been described in detail above with reference to the first aspect of the invention. Accordingly, the remarks set forth above are equally applicable here. The blade connecting tension member may be applied in a wind turbine as a blade connecting tension member, as described above. Alternatively or additionally, the blade connecting tension member may be applied for other purposes in the wind turbine, where a tension member is required, and where drag and/or noise may be an issue.

The surface texture providing layer may define a surface roughness within an interval defined as 0.100 mm<Rₐ<0.400 mm, such as 0.200 mm<Rₐ<0.300 mm, and/or within an interval defined as 0.200 mm<R_{z}<0.500 mm, such as 0.300 mm<R_{z}<0.400 mm. This has already been described in detail above.

The surface texture providing layer may comprise an inner layer arranged circumferentially with respect to the tension member core and an outer layer arranged circumferentially with respect to the inner layer, and the inner layer may define a higher surface roughness than the outer layer. This has already been described in detail above.

The outer layer may be or comprise a thermoplastic shrink foil. This has already been described in detail above. As an alternative, the outer layer may be provided in the form of a woven or braided layer, a coating or in the form of an extruded layer, e.g. a plastomer layer.

The inner layer may be or comprise a woven or braided layer. This has already been described in detail above.

The blade connecting tension member may further comprise one or more surface shaping elements arranged between the tension member core and an outer surface of the surface texture providing layer. This has already been described in detail above.

The tension member core may be made from a polymer material. This has already been described in detail above.

A thickness of the surface texture providing layer may be at most 15% of a cross sectional diameter of the tension member core. This has already been described in detail above.

An ultraviolet (UV) resistance of the surface texture providing layer may be higher than an ultraviolet (UV) resistance of the tension member core, and/or an erosion resistance of the surface texture providing layer may be higher than an erosion resistance of the tension member core and/or an aerodynamic drag defined by the surface texture providing layer may be lower than an aerodynamic drag defined by the tension member core and/or an acoustic emission of the surface texture providing layer may be lower than an acoustic emission of the tension member core. This has already been described in detail above.

According to a third aspect the invention provides a use of the blade connecting tension member as described above for blade connecting tension member of a pitch controlled wind turbine. According to this embodiment, the wind turbine blades of a wind turbine are connected to the hub via respective pitch systems and the connection points at the wind turbine blade for the blade connecting tension member cable are arranged to allow for pitching of the blades so the wind turbine blades are able to perform pitching movements relative to the hub, about a longitudinal axis arranged along the length of the wind turbine blades, in order to adjust an angle of attack between the wind turbine blades and the incoming wind.

### BRIEF DESCRIPTION OF THE DRAWINGS

The invention will now be described in further detail with reference to the accompanying drawings in which

FIGS. 1 and 2 illustrate a wind turbine according to an embodiment of the invention,

FIGS. 3-5 illustrate a blade connecting tension member according to an embodiment of the invention with a tension member core and an inner layer of a surface texture providing layer,

FIG. 6 shows a blade connecting tension member according to an embodiment of the invention with a tension member core and a surface texture providing layer,

FIGS. 7-10 are cross sectional views of blade connecting tension members according to various embodiments of the invention being provided with various surface shaping elements,

FIGS. 11 and 12 illustrate a blade connecting tension member according to an embodiment of the invention provided with a surface shaping element arranged in a helix pattern,

FIGS. 13-15 are graphs illustrating sound pressure level as a function of frequency for a smooth tension member and a blade connecting tension member according to an embodiment of the invention at three different wind speeds, and

FIG. 16 is a graph illustrating noise generated by a prior art wind turbine and by a wind turbine according to an embodiment of the invention, respectively, as a function of hub height wind speed.

### DETAILED DESCRIPTION OF THE DRAWINGS

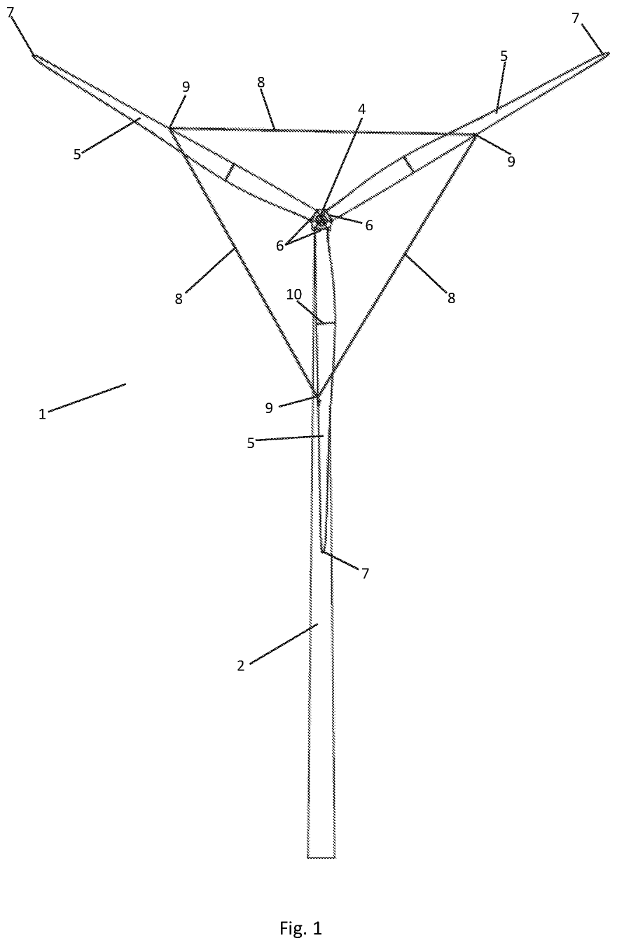

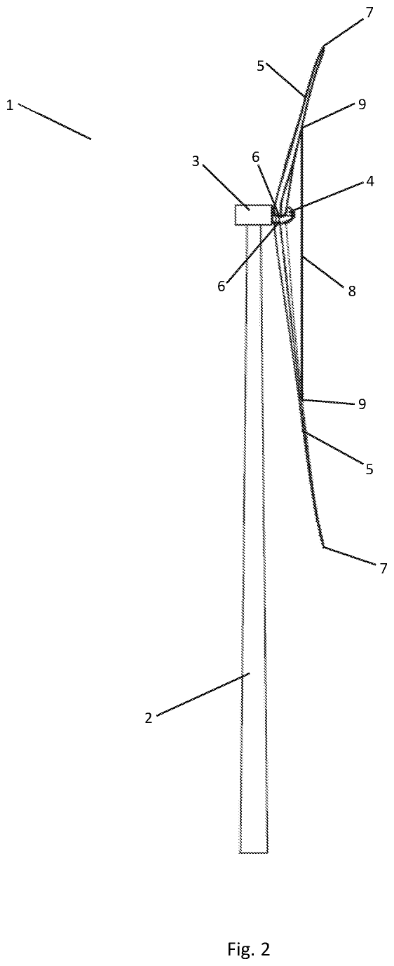

FIGS. 1 and 2 illustrate a wind turbine 1 according to a first embodiment of the invention. FIG. 1 is a front view of the wind turbine 1 and FIG. 2 is a side view of the wind turbine 1.

The wind turbine 1 comprises a tower 2, a nacelle 3 mounted on the tower 2 and a hub 4 mounted on the nacelle 2. Three wind turbine blades 5 are connected to the hub 4. Each wind turbine blade 5 extends between a root end 6 connected to the hub 4 and an oppositely arranged tip end 7.

The wind turbine 1 further comprises three blade connecting tension members 8. Each blade connecting tension member 8 interconnects two neighbouring wind turbine blades 5 by being connected to connection points 9 at the respective wind turbine blades 5. The wind turbine blades 5 are able to mutually support each other via the blade connecting tension members 8, in the sense that loads on the wind turbine blades 5, in particular edgewise loads and flapwise loads, are shared among the wind turbine blades 5, via the blade connecting tension members 8.

The blade connecting tension members 8 are of a kind which comprises a tension member core and a surface texture providing layer being arranged circumferentially with respect to the tension member core. Thereby the surface texture providing layer modifies or alters the surface texture of the blade connecting tension members 8, as compared to a surface texture of the tension member core. Accordingly, the surface texture of the surface texture providing layer defines the surface texture of the blade connecting tension members 8, while the tension member core defines other mechanical properties of the blade connecting tension members 8, e.g. in terms of strength, flexibility, elasticity, durability, etc.

The surface texture applied to the blade connecting tension members 8 in this manner has an impact on the aerodynamical properties of the blade connecting tension members 8 which causes a reduction in vortex induced vibrations in the blade connecting tension members 8. This reduces the drag introduced by the blade connecting tension members 8 during operation of the wind turbine 1. Furthermore, the noise originating from the blade connecting tension members 8 is reduced. Accordingly, the mutual support of the wind turbine blades 5 can be obtained without unduly decreasing the ability of the wind turbine 1 to extract energy from the wind, and without unduly increasing the noise generated by the wind turbine 1.

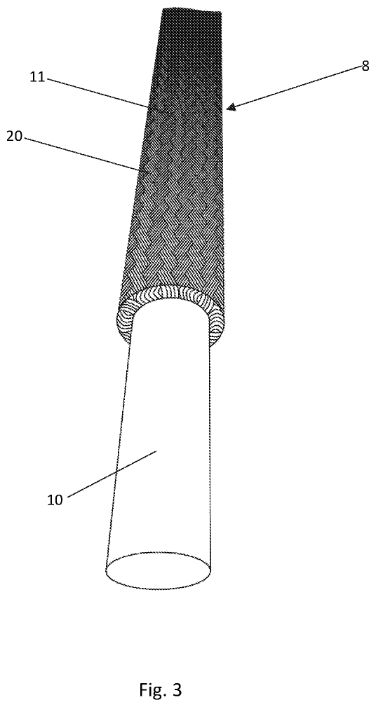

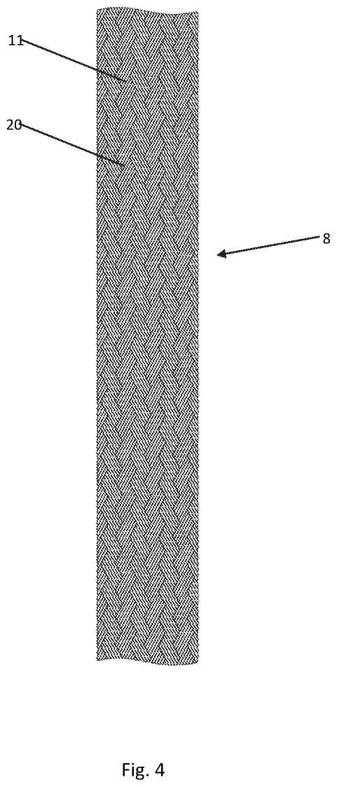

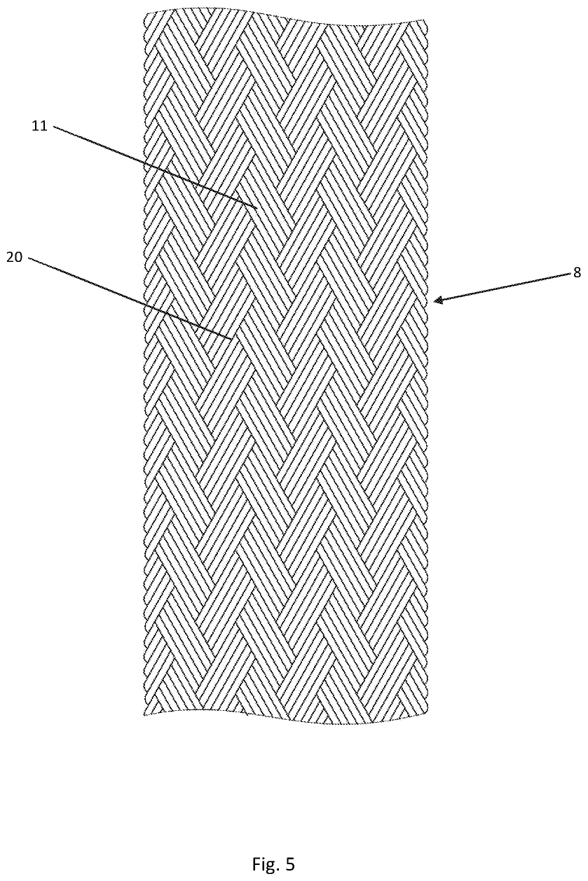

FIGS. 3-5 show a blade connecting tension member 8 according to an embodiment of the invention. FIG. 3 is a perspective view of the blade connecting tension member 8, FIG. 4 is a side view of the blade connecting tension member 8, and FIG. 5 is a close-up view of the blade connecting tension member 8.

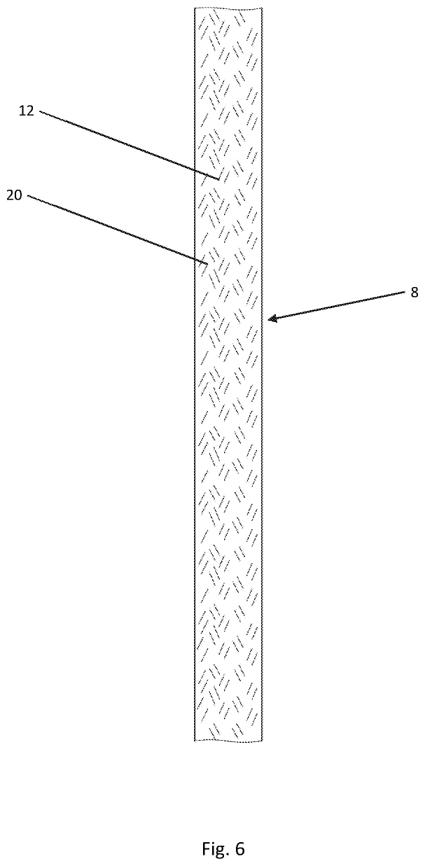

The blade connecting tension member 8 of FIGS. 3-5 comprises a tension member core 10. An inner layer 11, which is to form part of a surface texture providing layer of the blade connecting tension member 8, is arranged circumferentially with respect to the tension member core 10. The inner layer 11 is in the form of a braided layer, and a surface texture and a surface roughness of the inner layer 11 is defined by the strands of the braiding and the braiding pattern. It can be seen that the surface roughness is relatively high with abrupt changes in the surface level at positions where the strands of the braiding cross each other. This is particularly visible in FIG. 5. Other over braiding and over weaving patterns that what is shown in FIGS. 3-5 are well known to the skilled person. The inner layer 11 may be combined with an outer layer 12 (see FIG. 6) to form a surface texture providing layer 20, the outer layer 12 may be omitted so the surface texture providing layer 20 consist of one braided layer only.

FIG. 6 is a side view of a blade connecting tension member 8 according to an embodiment of the invention. The blade connecting tension member 8 comprises a tension member core (not visible) and a surface texture providing layer, in the form of an inner layer (not visible) and an outer layer 12, arranged circumferentially with respect to the tension member core. More particularly, the inner layer is arranged circumferentially with respect to the tension member core, and the outer layer 12 is arranged circumferentially with respect to the inner layer, i.e. the inner layer is arranged between the tension member core and the outer layer 12.

The tension member core and the inner layer may, e.g., be the tension member core 10 and the inner layer 11 illustrated in FIGS. 3-5. In the embodiment of FIG. 6, the outer layer 12 is in the form of a thermoplastic shrink foil which has been positioned circumferentially with respect to the inner layer, and subsequently subjected to heat in order to shrink the foil, thereby causing the outer layer 12 to follow the contours of the braided inner layer, but in a manner which smoothens the abrupt changes in surface levels defined by the braided pattern described above. Thereby the surface texture defined by the resulting outer layer 12 defines a surface roughness which is higher than the surface roughness of the tension member core, but lower than the surface roughness defined by the braided inner layer.

The surface roughness defined by the outer layer 12, with the braided inner layer underneath, ensures that vortex induced vibrations of the blade connecting tension member 8, as air moves along the blade connecting tension member 8, are reduced. Accordingly, if the blade connecting tension member 8 is mounted on a rotor of a wind turbine, e.g. as a blade connecting blade connecting tension member 8, the drag as well as the noise originating from the blade connecting tension member 8 will be reduced as compared to a blade connecting tension member without the surface texture providing layer.

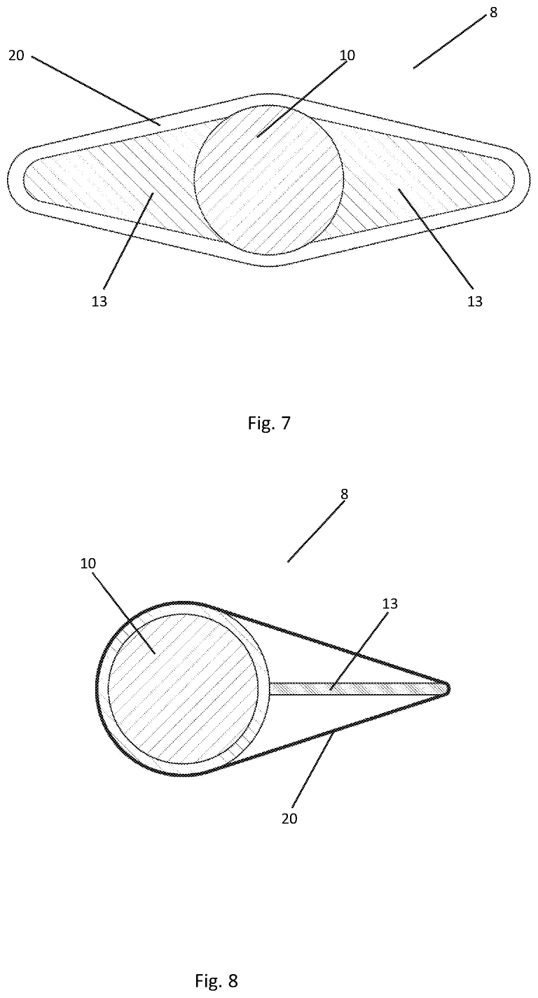

FIG. 7 is a cross sectional view of a blade connecting tension member 8 according to an embodiment of the invention. The blade connecting tension member 8 comprises a tension member core 10, a surface shaping elements 13 and a surface texture providing layer 20, arranged circumferentially with respect to the tension member core 10 and the surface shaping elements 13 thereby holding the surface shaping element 13 with the core.

The surface shaping elements 13 are in the form of additional core members arranged adjacent to the tension member core 10, between the tension member core 10 and the surface texture providing layer 20. Thereby the surface shaping elements 13 alter the cross sectional shape of the blade connecting tension member 8 from a circular shape to a non-circular airfoil shape. This changes the aerodynamical properties of the blade connecting tension member 8 in such a manner that the drag introduced by the blade connecting tension member 8, when air flows along the blade connecting tension member 8, is reduced.

FIG. 8 is a cross sectional view of a blade connecting tension member 8 according to an alternative embodiment of the invention. Similarly to the embodiment of FIG. 7, the blade connecting tension member 8 comprises a tension member core 10 a surface shaping element 13 and a surface texture providing layer 20 arranged circumferentially with respect to the tension member core 10 and the surface shaping elements 13 thereby holding the surface shaping element 13 with the core.

In the embodiment of FIG. 8, the surface shaping element 13 is in the form of a spacer extending from a surface of the tension member core 10, and arranged between the tension member core 10 and the surface texture providing layer 20. Accordingly, also in this case, the surface shaping element 13 alters the cross sectional shape of the blade connecting tension member 8, thereby changing the aerodynamical properties of the blade connecting tension member 8 in such a manner that the drag introduced by the blade connecting tension member 8 is reduced.

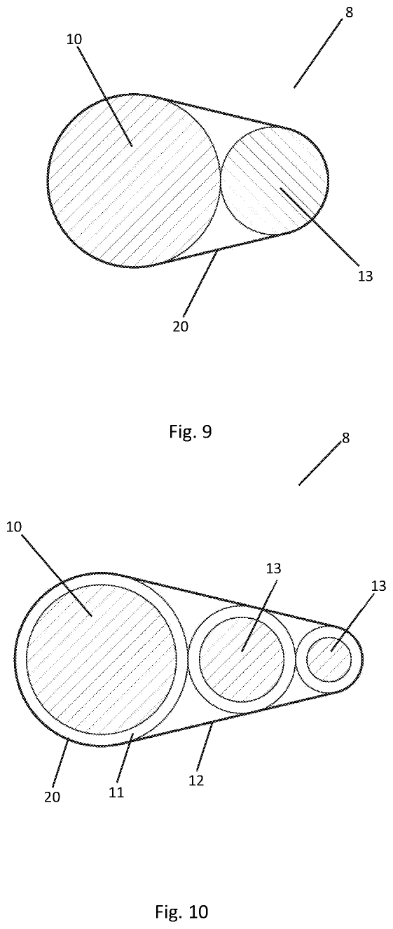

FIG. 9 is a cross sectional view of a blade connecting tension member 8 according to yet an alternative embodiment of the invention. Similarly to the embodiments of FIGS. 7 and 8, the blade connecting tension member 8 comprises a tension member core 10, a surface shaping element 13 and a surface texture providing layer 20, arranged circumferentially with respect to the tension member core 10 and the surface shaping elements 13 thereby holding the surface shaping element 13 with the core.

In the embodiment of FIG. 9, the surface shaping element 13 is arranged adjacent to the tension member core 10, and between the tension member core 10 and the surface texture providing layer 20, thereby altering the cross sectional shape of the blade connecting tension member 8 and the aerodynamical properties thereof in a manner similar to the embodiments described above with reference to FIGS. 7 and 8. In this embodiment, the surface shaping element may be a further tension member core, which in addition to altering the cross sectional shape of the blade connecting tension member 8 also provides a significant part of the mechanical properties of the blade connecting tension member 8, such as for example at least 20% of the overall strength of the blade connecting tension member 8.

It should be noted that, even though FIG. 9 shows the tension member core 10 and the surface shaping element 13 in close abutment, it is not ruled out that a small gap may be present between these two for example facilitated by a further surface shaping element 13 arranged between the tension member core 10 and the surface shaping element 13 forming the further tension member core.

FIG. 10 is a cross sectional view of a blade connecting tension member 8 according to yet an alternative embodiment of the invention. The blade connecting tension member 8 of FIG. 10 is very similar to the blade connecting tension member 8 of FIG. 9, and it will therefore not be described in detail here. However, in the blade connecting tension member 8 of FIG. 10, two surface shaping elements 13 in the form of further tension member cores of different cross sectional diameter are arranged between the tension member core 10 and the outer layer 12 of the surface texture providing layer 20, thereby affecting the cross sectional shape of the blade connecting tension member 8, and thereby the aerodynamic properties of the blade connecting tension member 8. Furthermore, in this embodiment, an inner layer 11 in the form of an overbraiding is also provided on the tension member core 10. Similar inner layers of overbraiding may also be present on the surface shaping elements 13.

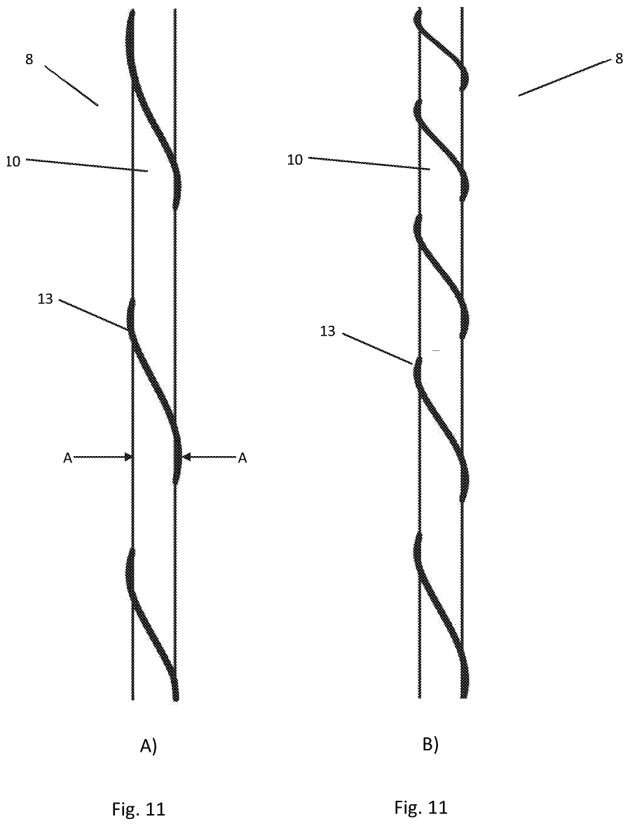

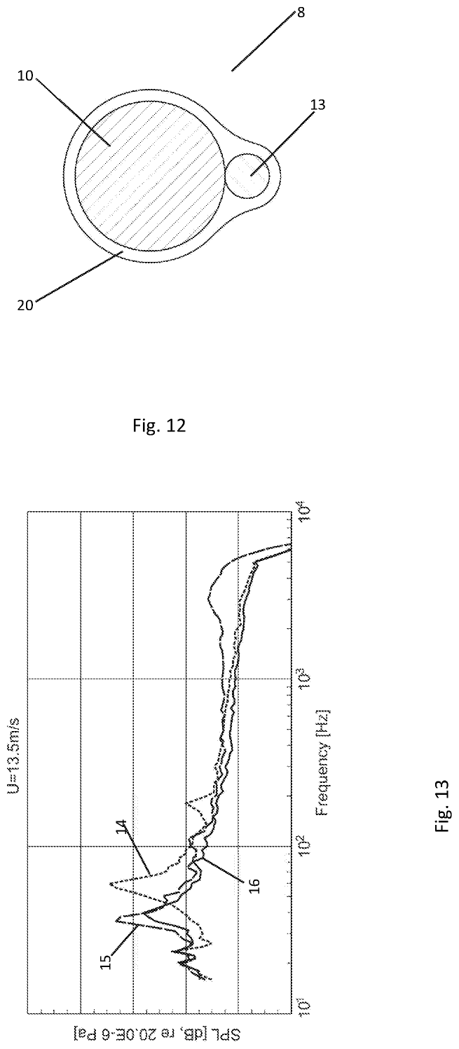

FIGS. 11 and 12 illustrate a blade connecting tension member 8 according to an embodiment of the invention. FIG. 11 is a side view of blade connecting tension members 8 and FIG. 12 is a cross sectional view of the blade connecting tension member 8 along the line A-A shown in FIG. 11A.

The blade connecting tension member 8 of FIGS. 11 and 12 comprises a tension member core 10 and a surface texture providing layer 20 arranged circumferentially with respect to the tension member core 10 (not shown in FIG. 11) and a surface shaping element 13 arranged between the tension member core 10 and the surface texture providing layer 20.

According to this embodiment, the surface shaping element 13 is in the form of a wire or string arranged along an outer surface of the tension member core 10 in a helical pattern. This provides a surface texture which guides air flowing along the blade connecting tension member 8 to follow a substantially helical path. This reduces vortex induced vibrations in the blade connecting tension member 8, thereby reducing the drag introduced by the blade connecting tension member 8 as well as the noise originating from the blade connecting tension member 8. In FIG. 11A, the helical pattern of the surface shaping element 13 is regular, whereas in FIG. 11B, the helical pattern has a varying pitch so the density of the surface shaping element 13 is higher towards the top of FIG. 11B than towards the bottom of FIG. 11B.

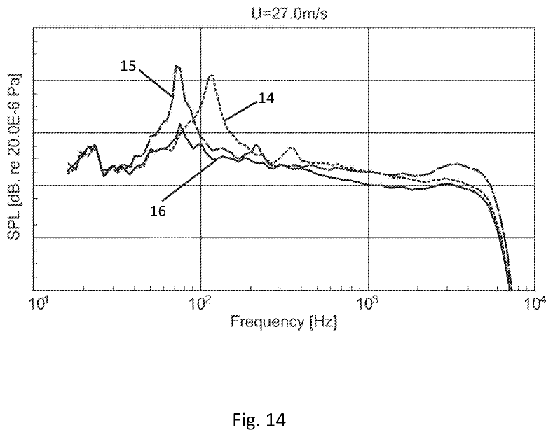

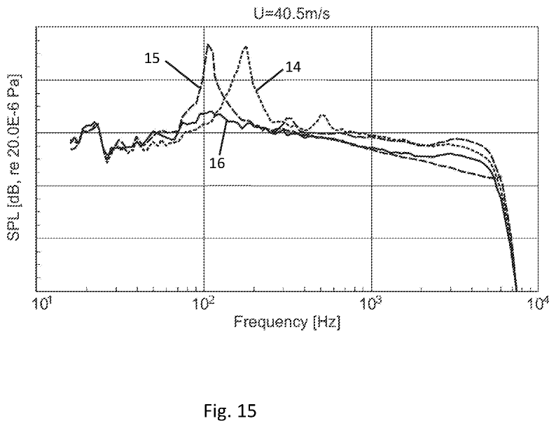

FIGS. 13-15 are graphs illustrating sound pressure level as a function of frequency for a smooth tension member and a blade connecting tension member according to an embodiment of the invention at three different wind speeds. The graphs of FIGS. 13-15 represent measurements performed in a wind tunnel where the respective tension members were positioned. The graph of FIG. 13 represents measurements performed at 13.5 m/s, FIG. 14 represents measurements performed at 27.0 m/s, and FIG. 15 represents measurements performed at 40.5 m/s.

In the graphs, curve 14 originates from a tension member with a substantially cylindrical shape and a substantially smooth outer surface, which for example may correspond to a tension member core without a surface texture providing layer applied thereto. Curve 15 originates from a blade connecting tension member with a tension member core and an inner layer, e.g. in the form of a braided layer as illustrated in FIGS. 3-5, arranged circumferentially with respect to the tension member core, but without an outer layer. Finally, curve 16 originates from a blade connecting tension member with a tension member core, an inner layer arranged circumferentially with respect to the tension member core, and an outer layer arranged circumferentially with respect to the inner layer, such as the blade connecting tension member illustrated in FIG. 6.

It can be seen that the curve 16 originating from the blade connecting tension member with an inner layer as well as an outer layer has the lowest sound pressure at most frequencies and at all the investigated wind speeds. Accordingly, the noise generated by the blade connecting tension member is reduced by applying a surface texture providing layer in the form of an inner layer and an outer layer, as described above.

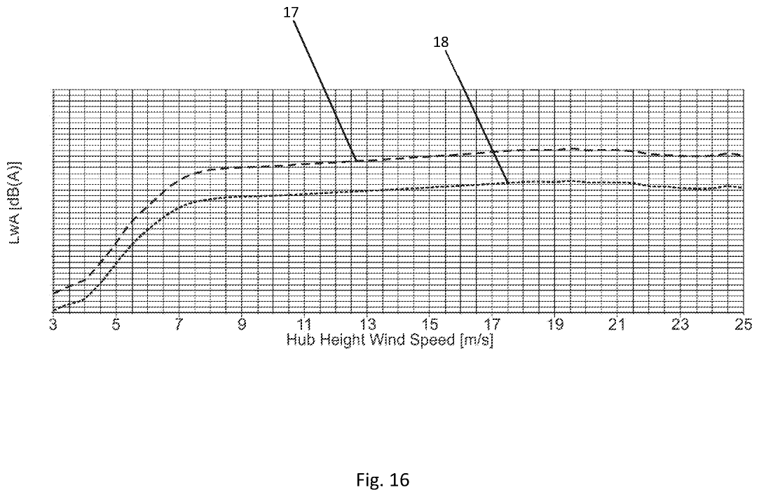

FIG. 16 is a graph illustrating noise generated by a wind turbine having tension members with a smooth surface and by a wind turbine according to an embodiment of the invention, respectively, as a function of hub height wind speed. Curve 17 represents the wind turbine having tension members with a smooth surface and curve 18 represents the wind turbine according to the invention, and the curves 17, 18 have been generated by simulation.

The wind turbine of curve 17 is of a kind, which is provided with blade connecting tension members. The blade connecting tension members have a substantially cylindrical shape and may be in the form of cables or wires with a smooth surface. Accordingly, the blade connecting tension members are not provided with a surface texture providing layer.

The wind turbine according to the invention is also of a kind which is provided with blade connecting tension members. However, in this case the blade connecting tension members comprise a tension member core and a surface texture providing layer arranged circumferentially with respect to the tension member core.

It can be seen that the noise generated by the wind turbine according to the invention, represented by curve 18, is lower than the noise generated by the prior art wind turbine, represented by curve 17, at all hub height wind speeds.

### ITEMS

1. A wind turbine (1) comprising a tower (2), a nacelle (3) mounted on the tower (2), a hub (4) mounted rotatably on the nacelle (3), and three or more wind turbine blades (5), wherein each wind turbine blade (5) extends between a root end (6) connected to the hub (4), and a tip end (7) arranged opposite to the root end (6), the wind turbine (1) further comprising blade connecting tension members (8), each blade connecting tension member (8) extending between a connection point (9) at one wind turbine blade (5) and a connection point (9) at a neighbouring wind turbine blade (5), where the connection point (9) at a given wind turbine blade (5) is arranged at a distance from the root end (6) and at a distance from the tip end (7) of the wind turbine blade (5), wherein each blade connecting tension member (8) comprises:
a tension member core (10), and
a surface texture providing layer (11, 12, 20) arranged circumferentially with respect to the tension member core (10), thereby modifying a surface texture of an outer surface of the blade connecting tension member (8).

2. The wind turbine (1) according to item 1, wherein the surface texture providing layer (11, 12, 20) defines a surface roughness within an interval defined as 0.100 mm<Rₐ<0.400 mm and/or within an interval defined as 0.200 mm<R_{z}<0.500 mm.

3. The wind turbine (1) according to item 1 or 2, wherein the surface texture providing layer comprises an inner layer (11) arranged circumferentially with respect to the tension member core (10) and an outer layer (12) arranged circumferentially with respect to the inner layer (11), wherein the inner layer (11) defines a higher surface roughness than the outer layer (12).

4. The wind turbine (1) according to item 3, wherein the outer layer (12) is or comprises a thermoplastic shrink foil, a coating or an extruded layer.

5. The wind turbine (1) according to item 3 or 4, wherein the inner layer (11) is or comprises a woven or braided layer.

6. The wind turbine (1) according to any of the preceding items, wherein the blade connecting tension member (8) further comprises one or more surface shaping elements (13) arranged between the tension member core (10) and an outer surface of the surface texture providing layer (11, 12, 20).

7. The wind turbine (1) according to any of the preceding items, wherein the tension member core (10) is made from a polymer material.

8. The wind turbine (1) according to any of the preceding items, wherein a thickness of the surface texture providing layer (11, 12, 20) is at most 15% of a cross sectional diameter of the tension member core (10).

9. The wind turbine (1) according to any of the preceding items, wherein the cross sectional area of the tension member core excluding metal is at least 90% of the cross sectional area of the blade connecting tension member, preferably the cross sectional area of the tension member core excluding metal is at least 95% of the cross sectional area of the blade connecting tension member.

10. The wind turbine (1) according to any of the preceding items, wherein an ultraviolet (UV) resistance of the surface texture providing layer (11, 12, 20) is higher than an ultraviolet (UV) resistance of the tension member core (10).

11. The wind turbine (1) according to any of the preceding items, wherein an erosion resistance of the surface texture providing layer (11, 12, 20) is higher than an erosion resistance of the tension member core (10).

12. The wind turbine (1) according to any of the preceding items, wherein an aerodynamic drag defined by the surface texture providing layer (11, 12, 20) is lower than an aerodynamic drag defined by the tension member core (10).

13. The wind turbine (1) according to any of the preceding items, wherein an acoustic emission of the surface texture providing layer (11, 12, 20) is lower than an acoustic emission of the tension member core (10).

14. The wind turbine (1) according to any of the preceding items, wherein the connection points (9) at the wind turbine blades (5) are arranged at a distance from the root end (6) which is between 25% and 60% of the length of the wind turbine blades (5) from the root end (6) to the tip end (7).

15. The wind turbine (1) according to any of the preceding items, wherein the wind turbine (1) is a pitch controlled wind turbine.

16. The wind turbine (1) according to any of the preceding items, further comprising pre-tension members arranged from each blade connecting tension member and towards a hub part.

17. A blade connecting tension member (8) for use in a wind turbine (1), the blade connecting tension member (8) comprising:
a tension member core (10), and
a surface texture providing layer (11, 12, 20) arranged circumferentially with respect to the tension member core (10), thereby modifying a surface texture of an outer surface of the blade connecting tension member (8).

18. The blade connecting tension member (8) according to item 17, wherein the surface texture providing layer (11, 12, 20) defines a surface roughness within an interval defined as 0.100 mm<Rₐ<0.400 mm and/or within an interval defined as 0.200 mm<R_{z}<0.500 mm.

19. The blade connecting tension member (8) according to item 17 or 18, wherein the surface texture providing layer comprises an inner layer (11) arranged circumferentially with respect to the tension member core (10) and an outer layer (12) arranged circumferentially with respect to the inner layer (11), wherein the inner layer (11) defines a higher surface roughness than the outer layer (12).

20. The blade connecting tension member (8) according to item 9, wherein the outer layer (12) is or comprises a thermoplastic shrink foil, a coating or an extruded layer.

21. The blade connecting tension member (8) according to item 19 or 20, wherein the inner layer (11) is or comprises a woven or braided layer.

22. The blade connecting tension member (8) according to any of items 17-21, further comprising one or more surface shaping elements (13) arranged between the tension member core (10) and an outer surface of the surface texture providing layer (11, 12, 20).

23. The blade connecting tension member (8) according to any of items 17-22, wherein the tension member core (10) is made from a polymer material.

24. The blade connecting tension member (8) according to any of item 17-23, wherein a thickness of the surface texture providing layer (11, 12, 20) is at most 15% of a cross sectional diameter of the tension member core (10).

25. The blade connecting tension member (8) according to any of items 17-24, wherein an ultraviolet (UV) resistance of the surface texture providing layer (11, 12, 20) is higher than an ultraviolet (UV) resistance of the tension member core (10).

26. The blade connecting tension member (8) according to any of items 17-25, wherein an erosion resistance of the surface texture providing layer (11, 12, 20) is higher than an erosion resistance of the tension member core (10).

27. The blade connecting tension member (8) according to any of items 17-26, wherein an aerodynamic drag defined by the surface texture providing layer (11, 12, 20) is lower than an aerodynamic drag defined by the tension member core (10).

28. The blade connecting tension member (8) according to any of items 17-27, wherein an acoustic emission of the surface texture providing layer (11, 12, 20) is lower than an acoustic emission of the tension member core (10).

29. Use of the blade connecting tension member (8) according to any of items 17-28 for blade connecting tension member (8) of a pitch controlled wind turbine (1).

1. A wind turbine comprising a tower, a nacelle mounted on the tower, a hub mounted rotatably on the nacelle, and three or more wind turbine blades, wherein each wind turbine blade extends between a root end connected to the hub, and a tip end arranged opposite to the root end, the wind turbine further comprising blade connecting tension members, each blade connecting tension member extending between a connection point at one wind turbine blade and a connection point at a neighbouring wind turbine blade, where the connection point at a given wind turbine blade is arranged at a distance from the root end and at a distance from the tip end of the wind turbine blade, wherein each blade connecting tension member comprises:
a tension member core, and
a surface texture providing layer arranged circumferentially with respect to the tension member core, thereby modifying a surface texture of an outer surface of the blade connecting blade connecting tension member.

2. The wind turbine according to claim 1, wherein the surface texture providing layer defines a surface roughness within an interval defined as 0.100 mm<Rₐ<0.400 mm and/or within an interval defined as 0.200mm<R_{z}<0.500 mm.

3. The wind turbine according to claim 1, wherein the surface texture providing layer comprises an inner layer arranged circumferentially with respect to the tension member core and an outer layer arranged circumferentially with respect to the inner layer, wherein the inner layer defines a higher surface roughness than the outer layer.

4. The wind turbine according to claim 3, wherein the outer layer is or comprises a thermoplastic shrink foil, a coating or an extruded layer.

5. The wind turbine according to claim 3, wherein the inner layer is or comprises a woven or braided layer.

6. The wind turbine according to claim 1, wherein the blade connecting tension member further comprises one or more surface shaping elements arranged between the tension member core and an outer surface of the surface texture providing layer.

7. The wind turbine according to claim 1, wherein the tension member core is made from a polymer material.

8. The wind turbine according to claim 1, wherein an aerodynamic drag defined by the surface texture providing layer is lower than an aerodynamic drag defined by the tension member core.

9. The wind turbine according to claim 1, wherein an acoustic emission of the surface texture providing layer is lower than an acoustic emission of the tension member core.

10. The wind turbine according to claim 1, wherein the wind turbine is a pitch controlled wind turbine.

11. A blade connecting tension member for use in a wind turbine, the blade connecting tension member comprising:
a tension member core, and
a surface texture providing layer arranged circumferentially with respect to the tension member core, thereby modifying a surface texture of an outer surface of the blade connecting tension member.

12. The blade connecting tension member according to claim 11, further comprising one or more surface shaping elements arranged between the tension member core and an outer surface of the surface texture providing layer.

13. The blade connecting tension member according to claim 11, wherein an aerodynamic drag defined by the surface texture providing layer is lower than an aerodynamic drag defined by the tension member core.

14. The blade connecting tension member according to claim 11, wherein an acoustic emission of the surface texture providing layer is lower than an acoustic emission of the tension member core.

15. (canceled)

16. A method of operating a wind turbine, the wind turbine comprising a tower, a nacelle mounted on the tower, a hub mounted rotatably on the nacelle, and three or more wind turbine blades, wherein each wind turbine blade extends between a root end connected to the hub, and a tip end arranged opposite to the root end, the wind turbine further comprising blade connecting tension members, each blade connecting tension member extending between a connection point at one wind turbine blade and a connection point at a neighbouring wind turbine blade, where the connection point at a given wind turbine blade is arranged at a distance from the root end and at a distance from the tip end of the given wind turbine blade, wherein each blade connecting tension member comprises:
a tension member core, and
a surface texture providing layer arranged circumferentially with respect to the tension member core, thereby modifying a surface texture of an outer surface of the blade connecting tension member; and
wherein the method, comprises:
starting up the wind turbine; and
producing power for delivery to a grid.
